(19) United States
(12) Patent Application Publication
(10) Pub. No.: US 2005/0219558 A1
(43) Pub. Date: Oct. 6, 2005

(54) Image registration using the perspective of the image rotation

(76) Inventors: Zhengyuan Wang, Singapore (SG); Adrian Mondry, Singapore (SG)

Correspondence Address: PROSKAUER ROSE LLP;PATENT DEPARTMENT, 1585 BROADWAY, NEW YORK, NY, 10036-8299, US

(21) Appl. No.: 11/012,960

(22) Filed: Dec. 15, 2004

Related U.S. Application Data
(60) Provisional application No. 60/530,530, filed on Dec. 17, 2003.

(51) Int. Cl. G06F 15/00

(52) U.S. Cl. 358/1.2

(57) ABSTRACT

The present invention provides a method for image registration that does not require the use of optimization techniques. Rather, the present method for image registration utilizes the perspective of image rotation.

### RELATED APPLICATION

This application claims the benefit of U.S. Provisional Application No. 60/530,530, filed Dec. 17, 2003, herein incorporated by reference.

### BACKGROUND OF THE INVENTION

1. Field of Invention

The present invention relates to a method and system or image registration and in particular to a method and system for image registration that uses the perspective of image rotation.

2. Description of the Prior Art

Image registration has a wide range of applications including medical image registration, pattern recognition, artificial intelligence and machine vision.

Existing methods for image registration can be broadly classified as either intensity based methods or feature based methods. Intensity based methods try to find the best deformation such that an image intensity similarity measure is maximized. Most methods in this class allow highly complex volumetric deformations in order to account for anatomical variability. Spline models, elastic media models, viscous fluid models or other local smoothness models have been introduced as constraints to guide the spatial mapping. Correlation coefficient, distance transformation and mutual information have also been used in these methods.

The feature based approach solves the registration problem by matching sets of features that range the gamut of landmark points, curves or surfaces. Current feature matching processes often employ optimization techniques to search for a solution. Examples of feature based techniques can be found in Chui. H, Win. L, Schults. R, Duncan. J, Rangarajan. A, “A Unified Feature Registration Method For Brain Mapping”, Information Processing in Medical Imaging, pp 300-314, 2001, and Gold. S, Rangarajan. A, Lu. C, Pappu. S, Emjolsness, “New Algorithms for 2D and 3D Point Matching: Pose Estimation and Correspondence”, Pattern Recognition, vol 31, pp 1019-1031, 1998.

One disadvantage of existing techniques is that they can be time consuming. Another disadvantage that particularly applies to optimizing methods is that a blind guess at the start of the process may trap the process and a proper solution may never be found.

### BRIEF SUMMARY OF THE INVENTION

It is an object of the present invention to provide a method for image registration that does not require the use of optimization techniques.

In broad terms the invention comprises a method of image registration including the steps of providing at least one point set related to the features of a reference image, providing at least one point set related to the features of a transformed image, estimating the translation between the reference image point set and the transformed image point set, estimating the perspective of the image rotation for the reference image point set and the transformed image point set, estimating the rotation between the reference image point set and the transformed image point set using the perspectives of the image rotation of the reference and transformed image point sets, rotating the reference image point set or the transformed image point set by the estimated rotation, translating the reference image point set or the transformed image point set by the estimated translation, and wherein the step of translating the reference image point set or the transformed image point set can be performed at any stage after the translation has been estimated.

Preferably the method further includes the step of rotating the reference image by the estimated rotation, using a feature extraction method to determine a second reference image point set and comparing this point set to the transformed image point set.

Preferably the method further includes the step of re-estimating the rotation after rotating the reference image and determining the second reference image point set.

Preferably the method further includes the step of re-estimating the translation from the geometric centers of the second reference image point set and the transformed image point set and reapplying the re-estimated rotation and translation to the second reference image point set or the transformed image point set.

Preferably the translation is determined by the difference between the geometric centers of the reference image point set and the transformed image point set.

Preferably the perspectives of the image rotation are determined as the sum over all points in the reference or transformed image data sets of the absolute value of the cross product of a vector from the geometric centre to each data point and a unit vector along a rotating axis at a predetermined angle.

Ideally the rotating axis rotates about the geometric centre of the point set.

Preferably rotation is determined by finding the minimum of the difference between the perspective of the image rotation of the reference point set with a phase offset and the perspective of the image rotation of each transformed point set. Ideally this is summed over the interval of −π/2 and π/2.

### BRIEF DESCRIPTION OF DRAWINGS

The invention will be further described by way of example only and without intending to be limiting with reference to the following drawings, wherein:

FIG. 1 is a flow chart showing the method of the invention;

FIG. 2A shows the plotted points from a two dimensional point set and the projection of one point onto an axis;

FIG. 2B shows the plotted points from a two dimensional point set and the projection of one point onto an axis that has been rotated;

FIG. 2C shows the plotted points from a three dimensional point set and the projection of one point onto an axis that has been rotated;

FIG. 2D shows the plotted points from a three dimensional point set and the projection of one point onto an axis that has been rotated;

FIG. 2E shows the plotted points from a three dimensional point set and the projection of one point onto an axis that has been rotated;

FIG. 3A is a graph showing an example of two perspectives of the image rotation, one from a reference image point set and the other from a transformed image point set;

FIG. 3B is a graph showing an example of two perspectives of the image rotation, one from a reference image point set and the other from a transformed image point set;

FIG. 3C is a graph showing an example of two perspectives of the image rotation, one from a reference image point set and the other from a transformed image point set;

FIG. 4A shows a reference image;

FIG. 4B shows a transformed image;

FIG. 5A shows a reference image;

FIG. 5B shows a transformed image;

FIG. 6A shows a reference image;

FIG. 6B shows a transformed image;

FIGS. 7A, 7B, 7C, 7D, 7E, 7F, 7G, 7H, 7I, 7J, 7K and 7L show CT images of a skull;

FIGS. 8A and 8B show further CT images of a skull;

FIG. 9A shows a reference image of an abdomen and upper legs;

FIG. 9B shows a transformed image of an abdomen and upper legs with a broken femur;

FIG. 10A is a graph showing registration error distribution for rotation errors;

FIG. 10B is a graph showing translation error distribution for horizontal translation; and

FIG. 10C is a graph showing translation error distribution for vertical translation.

### DETAILED DESCRIPTION

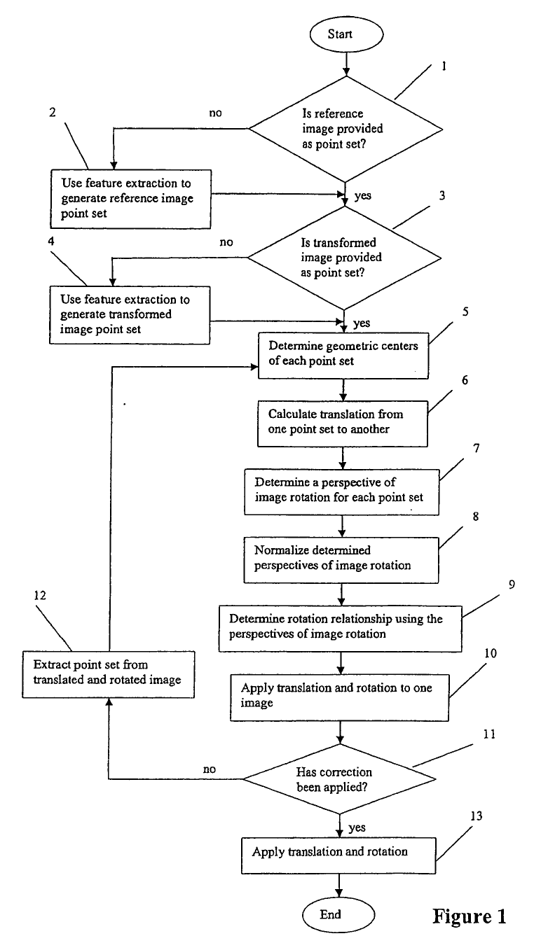

FIG. 1 is an algorithm showing the steps taken for image registration using the method of the invention. In step 1 the question is asked whether the reference image is provided as a point set. If the reference image is provided as a point set the “yes” arrow is followed to step 3. If the reference image isn't provided as a point set the “no” arrow is followed to step 2 and a point set for the reference image is generated using a known technique such as feature extraction, edge-detection, segmentation or boundary-detection. Once a point set is provided for the reference image the arrow is followed to step 3.

In step 3 the question is asked whether the transformed image is provided as a point set. Again if the transformed image is provided as a point set the “yes” arrow is followed to step 5. If the transformed image is not provided as a point set the “no” arrow is followed to step 4. In step 4 a known technique such as feature extraction, edge-detection, segmentation or boundary-detection is performed on the image to provide a point set. Once the point set is provided the arrow is followed to step 5.

The point sets for the reference and transformed images can be either in two ( [symbol] ²) or three dimensions ( [symbol] ³). With two-dimensional data the point sets can be represented by reference image point set={(xᵢ, yᵢ)},i=1,2,3 . . . N₁ and transformed image point set={(xᵢ, yᵢ)},i=1,2,3 . . . N₂ respectively, where N₁ and N₂ are the number of points in each of the point sets. With three-dimensional data the point sets can be represented by reference image point set={(zᵢ, xᵢ,yᵢ)},i=1,2,3 . . . N₁ transferred image point set={(zᵢ, xᵢ,yᵢ)},i=1,2,3 . . . N₂, respectively where N₁ and N₂ are the number of points in each of the point sets. The number of points in the two point sets is not necessarily the same and the point sets are not necessarily in the right order: the actual correspondence between the point sets is unknown. The reference image, represented by the reference image point set, can be registered to the transformed image, represented by the transformed image point set, through translation T and rotation R.

In step 5 the geometric centers of the reference image point set and the transformed image point set are determined. The geometric centers can be estimated as:

$$\begin{matrix}\begin{matrix}{x}_{c1} = \frac{1}{{N}_{1}} {\sum }_{( {x}_{i} , {y}_{i} ) ∈ A} {x}_{i} , & & {y}_{c1} = \frac{1}{{N}_{1}} {\sum }_{( {x}_{i} , {y}_{i} ) ∈ A} {y}_{i}\end{matrix} & 1 \\ \begin{matrix}{x}_{c2} = \frac{1}{{N}_{2}} {\sum }_{( {x}_{j} , {y}_{j} ) ∈ B} {x}_{j} , & {y}_{c2} = \frac{1}{{N}_{2}} {\sum }_{( {x}_{j} , {y}_{j} ) ∈ B} {y}_{j}\end{matrix} & 2\end{matrix}$$

In equations 1 and 2 A and B represent the reference image point set and the transformed image point set respectively. The above equations estimate the geometric centre of two-dimensional data but this can easily be extended to three dimensional data using the following:

$$\begin{matrix}{x}_{c3} = \frac{1}{{N}_{3}} {\sum }_{( {x}_{k} , {y}_{k} , {z}_{k} ) ∈ C} {x}_{k} , & {y}_{c3} = \frac{1}{{N}_{3}} {\sum }_{( {x}_{k} , {y}_{k} , {z}_{k} ) ∈ C} {y}_{k} , \\ {z}_{c3} = \frac{1}{{N}_{3}} {\sum }_{( {x}_{k} , {y}_{k} , {z}_{k} ) ∈ C} {z}_{k} & \end{matrix} \qquad 3$$

where the point set C contains N₃ points.

Once the geometric center of each point set has been calculated in step 6 the translation from one point set to another is determined. This can be calculated as:
T={(x_{c2}−x_{c1}), (y_{c2}−y_{c1})} 4
in two dimensions. In three dimensions the translation from one point set to another can be calculated as:
T32 {(x_{c2}−x_{c1}), (y_{c2}−y_{c1}), (z_{c2}−z_{c1})} 5

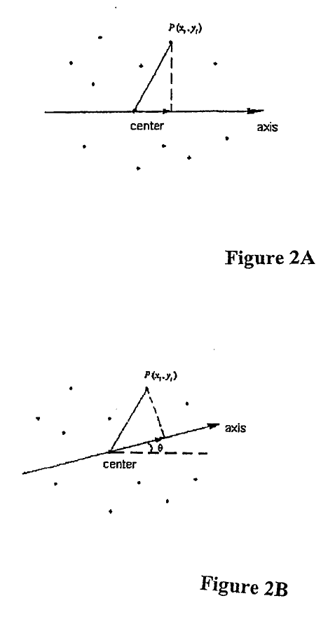

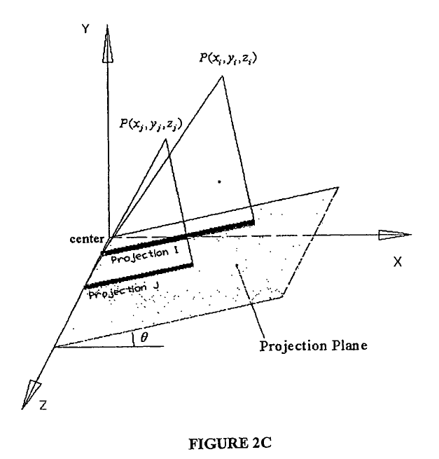

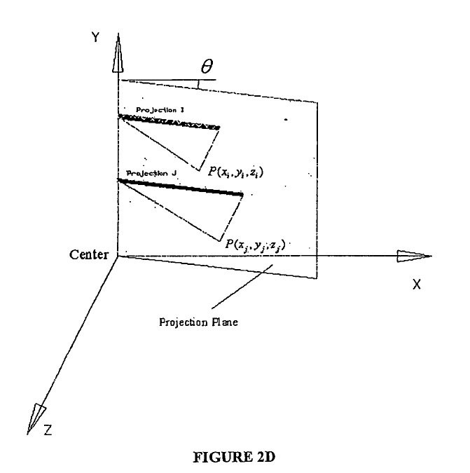

To determine the rotation between the reference image point set and the transformed image point set a perspective of the image rotation is formed for each point set as shown in step 7. The perspective of the image rotation is formed as the sum of vector cross products of vectors from the geometric center to points in the point set and a unit vector that rotates about an axis through the geometric center of the image. FIGS. 2A and 2B show generation of the perspective of the image rotation. In FIG. 2A the axis about the geometric center is not rotated and points from the point set are projected onto the axis as shown by the dotted line and vector in this image. In FIG. 2B the axis rotating about the geometric center of the image is rotated by an angle θ and the points of the point set are again projected onto the axis. The rotating axis is rotated from −π/2 to π/2 to produce the perspective of the image rotation. Due to the fact that the axis crosses the geometric center, the summation of the point projections will usually be around zero, which does not give proper perspective to the image characteristics. Therefore, the absolute values of the point projections are used instead in the perspective of the image rotation. The perspective of the image rotation for point set A is:

$${IRP}_{A} ( θ ) \hat{=} {\sum }_{( {x}_{i} , {y}_{i} ) ∈ A} ‖ {{P}^{->}}_{A} ( {x}_{i} , {y}_{i} ) ⊗ {{e}^{->}}_{θ} ‖ \qquad 6$$

where \vec{P}_{A}(xᵢ, y₁) is the vector from the geometric center to the ith point in the point set A, and \vec{e}_{θ} is the unit vector starting from the geometric center pointing to positive infinity along the axis with rotation θ. The perspective of the image rotation is taken for each data point set in step 7.

FIG. 2C shows projection of data points in three dimensions. In two dimensions a vector is rotated about the geometric centre of the point set. In three dimensions a projection plane is rotated about each of the three orthogonal axes with the origin of the axes at the geometric centre of the three dimensional point set. FIG. 2C shows the rotation of the projection plane by angle θ about the geometric centre of a point set and the projections of two points P(xᵢ, yᵢ, zᵢ) onto the projection plane. Projection onto the XY plane is shown in FIG. 2C. This leads to the perspectives of image rotation equations for point sets A and B in the XY plane.

$$\begin{matrix}{IRP}_{A}^{xy} ( θ ) = {\sum }_{( {x}_{i} , {y}_{i} , {z}_{i} ) ∈ A} ‖ {{P}^{->}}_{A} ( {x}_{i} , {y}_{i} , {z}_{i} ) ⊗ {{e}^{->}}_{θ}^{xy} ‖ \\ {IRP}_{B}^{xy} ( θ ) = {\sum }_{( {x}_{i} , {y}_{i} , {z}_{i} ) ∈ B} ‖ {{P}^{->}}_{B} ( {x}_{i} , {y}_{i} , {z}_{i} ) ⊗ {{e}^{->}}_{θ}^{xy} ‖\end{matrix}$$

Projection onto the XZ plane is shown in FIG. 2D. This leads to the perspectives of image rotation equations for point sets A and B in the XZ plane

$${IRP}_{A}^{xz} ( θ ) = {\sum }_{( {x}_{i} , {y}_{i} , {z}_{i} ) ∈ A} ‖ {{P}^{->}}_{A} ( {x}_{i} , {y}_{i} , {z}_{i} ) ⊗ {{e}^{->}}_{θ}^{xz} ‖$$

$${IRP}_{B}^{xz} ( θ ) = {\sum }_{( {x}_{i} , {y}_{i} , {z}_{i} ) ∈ B} ‖ {{P}^{->}}_{B} ( {x}_{i} , {y}_{i} , {z}_{i} ) ⊗ {{e}^{->}}_{θ}^{xz} ‖$$

Projection onto the YZ plane is shown in FIG. 2E. This leads to the perspectives of image rotation equations for point sets A and B in the YZ plane

$$\begin{matrix}{IRP}_{A}^{yz} ( θ ) = {\sum }_{( {x}_{i} , {y}_{i} , {z}_{i} ) ∈ A} ‖ {{P}^{->}}_{A} ( {x}_{i} , {y}_{i} , {z}_{i} ) ⊗ {{e}^{->}}_{θ}^{yz} ‖ \\ {IRP}_{B}^{yz} ( θ ) = {\sum }_{( {x}_{i} , {y}_{i} , {z}_{i} ) ∈ B} ‖ {{P}^{->}}_{B} ( {x}_{i} , {y}_{i} , {z}_{i} ) ⊗ {{e}^{->}}_{θ}^{yz} ‖\end{matrix}$$

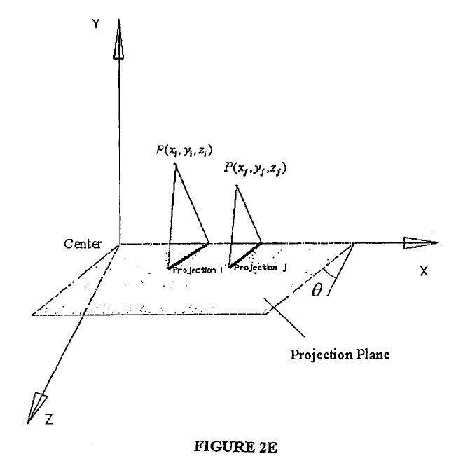

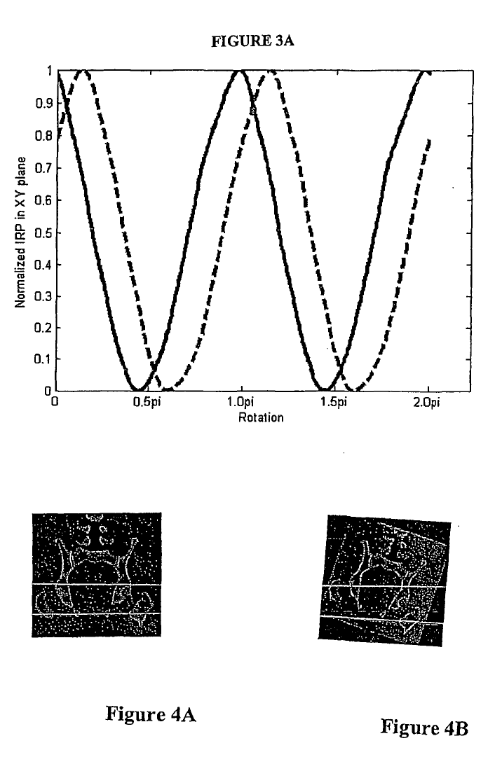

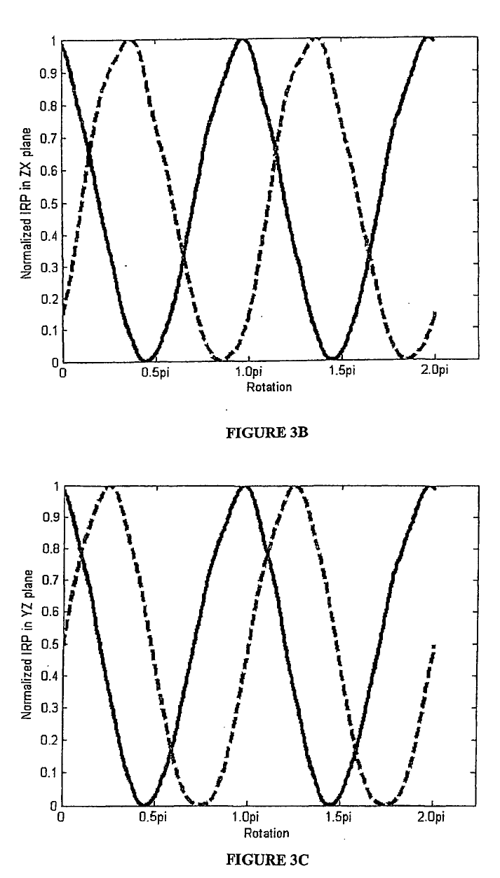

In step 8 the perspectives of the image rotation are normalized to between zero and one. This is done because of image scaling in the perspectives of the image rotation and allows the perspectives of the image rotation from different images to be analyzed against each other with different scale information. FIG. 3A shows a typical image of normalized perspectives of the image rotation to two point sets, A and B. If the data is two dimensional only the perspective of image rotation generated will be that of FIG. 3A for the XU plane. If the data is three dimensional the perspectives of image rotation for the XZ and YZ planes will also be generated as shown in FIGS. 3B and 3C respectively.

In three dimensions the perspectives of image rotation are aligned in pairs IRP_{A}^{xy}|IRP_{B}^{xy}, IRP_{A}^{xz}|IRP_{B}^{xz}, IRP_{A}^{yz}|IRP_{B}^{yz} to calculate the rotation in three dimensions. Again, the perspectives of image rotation are normalised to eliminate differences in scale information.

In step 9 the rotation relationship between two point sets, for example the reference image point set and the transformed image point set, is obtained through minimizing the difference between the perspectives of the image rotation:

$$\hat{φ} = {arg min}_{φ ∈ Θ} {\sum }_{{θ}_{i} ∈ Θ} ‖ {IRP}_{A} ( {θ}_{i} + φ ) - {IRP}_{B} ( {θ}_{i} ) ‖ \qquad 7$$

where Θ define the rotation domain [−π/2, π/2]. Since \hat{φ} comes from the domain [−π/2, π/2], equation 7 can be solved by direct numerical search of this domain. If the domain is divided into small segments with the length of π/512, it can be solved quickly. This eliminates the need for complex optimization techniques.

For three dimensional point sets equation 7 is applied three times—once for every orthogonal axis. It should be noted that the same set of axes must be applied to each point set. Applying equation 7 three times to produce three angles representing the rotation in each of the three directions. Each angle is constrained to [−π/2, π/2].

Once the translation and rotation have been assessed they are applied to one of the images in step 10. Typically the reference image will be rotated by φ (or by three angles for three dimensional data) and then translated so that the geometric centers of the reference image and transformed image coincide with each other. In an alternative embodiment the transformed image can be rotated and translated instead of the reference image.

Following this a series of correction steps may be performed to ensure a good fit between the rotated and translated reference image and the transformed image. The first question is whether the correction has already been performed at question box 11. If the correction steps have already been performed then the algorithm follows the yes arrow to step 13, if the correction steps haven't been performed then the algorithm proceeds to step 12.

In step 12 a point set is extracted from the rotated and transformed image, generally the reference image. This extraction can be by any known technique as described previously with reference to steps 2 and 4. After feature extraction the arrow is followed back to step 5 and the steps of determining the geometric centers and the perspective of the image rotation of each image are commenced.

When question box 11 is reached for the second time the “yes” arrow is followed to step 13 then the corrected translation is calculated from the corrected geometric centers based on the rotation from the first run of steps 5 to 9 and the correction from the second run of steps 5 to 9.

It has been found experimentally that using only one correction stage is sufficient to provide accurate registration of images. However, any number of correction stages could be used, although the amount of additional accuracy in image registration is likely to shrink at each addition correction stage.

### EXAMPLES

The invention will be further demonstrated by way of the following examples. In the following examples the CT images used come from the Visible Human Project with original data from the National Library of Medicine, Bethesda, Md., USA. The male subject is 39 years old and deceased from drug overdose. CT scanning was performed over the whole body at medium resolution. The scanning gives 587×341 pixels over a 587×341 mm field of view in the axial direction, 587×1878 pixels over a 587×1878 mm field of view in the coronal direction and 341×1878 pixels over a 341×1878 mm field of view in the sagittal direction. The distances between two adjacent slices are all 1 mm in the three directions. Due to the size of the coronal and sagittal images, these images are cut in the examples to smaller images, at the same locations measured in the number of pixels either from the front or from the ground line.

In the examples point sets were extracted from images using gradient-based edge-detection. The Canny method was used due to its robustness to noise. This method is described in Canny, J., “A Computational Approach to Edge Detection”, IEEE Transactions on Pattern Analysis and Machine Intelligence, vol PAMI-8, No.6, pp 679-698, 1986. It should be noted that any other suitable method for producing a point set could be used instead of the method used in the examples. The Canny method uses two different thresholds to detect strong and weak edges, and includes the weak edges in the output only if they are connected to strong edges. Point sets from both the floating image and the reference image are generated. Thresholding is done and standard operations of dilation and erosion are used to eliminate the trivial edge information in the image. The thresholding value is adjusted according to the quality of the images. In image dilation and erosion, the morphological structuring element takes the form of a square with a side-width of six pixels in all the examples.

The transformed images used in the examples were generated by translating and rotating actual CT images. The registration accuracy can be directly quantified by comparing the result to the known transformation. To investigate the performance of the algorithm under noise that may arise from the imaging process, Gaussian noise was added to the CT images at different levels.

One method to check the registration result is by visual inspection. Alternatively, the registration result can be compared with that of human expert registration, but these methods are not easy to quantify accurately. In the following examples, the transformed images are generated from the images of the Visible Human Project through a series of known transformations. The registration accuracy is thus easily quantified.

### Example 1

The image is taken from a CT image with soft tissue information. The reference image was of a whole human body but has been cut down to get an image size of 340×340 pixels. FIGS. 4A and 4B show the reference and floating images. Thresholding is applied to filter out trivial information. In this example the thresholding value is set as 100 based on the image quality. To show the strength of the algorithm of FIG. 1, the example was repeated nineteen times with different rotations in each repeat. Clockwise rotation of the image is defined as negative rotation and counter-clockwise rotation is defined as positive rotation. In this example rotation of the image is measured in degrees. The image translation was the same in each repeat of the example, being forty pixels in the X direction and sixty pixels in the Y direction. Table 1 shows the results of Example 1.

TABLE 1

| True Rotation | Estimated Rotation | Estimated Translation |
|---|---|---|
| −85 | −85.08 | 39.42, 60.06 |
| −75 | −74.88 | 39.49, 60.00 |
| −65 | −64.69 | 40.53, 59.44 |
| −55 | −55.20 | 39.84, 60.46 |
| −45 | −45.00 | 40.19, 59.63 |
| −35 | −34.80 | 39.64, 60.00 |
| −25 | −25.31 | 39.39, 60.13 |
| −15 | −15.82 | 40.10, 60.99 |
| −5 | −4.92 | 39.57, 59.87 |
| 0 | 0.00 | 40.00, 60.00 |
| 5 | 4.22 | 39.42, 59.90 |
| 15 | 15.82 | 40.56, 59.22 |
| 25 | 25.66 | 40.60, 60.46 |
| 35 | 34.45 | 39.59, 59.89 |
| 45 | 45.00 | 40.43, 59.99 |
| 55 | 55.20 | 39.97, 59.56 |
| 65 | 64.69 | 39.86, 59.30 |
| 75 | 74.53 | 39.00, 60.01 |
| 85 | 84.72 | 40.21, 59.47 |

As can be seen from Table 1 as the rotation moves from 85 degrees clockwise to 85 degreed counter-clockwise, the estimated registration result are close to the true transformation. The rotation errors do not exceed 1 degree and the translation error in both directions doesn't exceed 1 pixel.

### Example 2

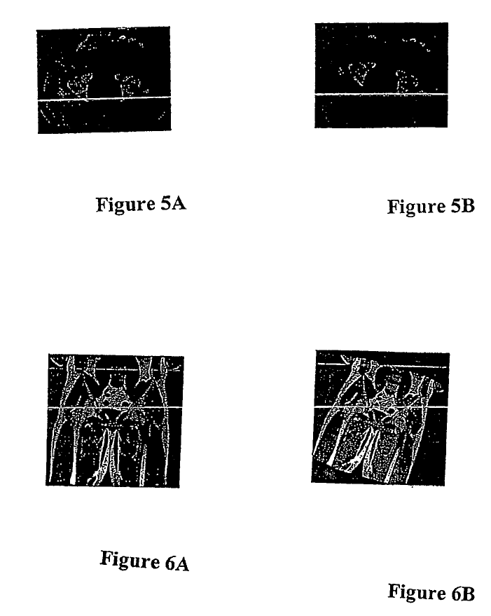

FIGS. 5A and 5B show a CT image used in this example. This image is a bone CT image. The blank margins of the image have been cut off to provide an image of 455×455 pixels. The thresholding value is set at 70. As with Example 1 in this example the registration is repeated for numerous different image rotations with the same translation between the reference and the transformed image. In this example the translation was 75 pixels in the X direction and 100 pixels in the Y direction. Again the image rotation if between 85 degrees clockwise and 85 degrees counter-clockwise. The results of this example are shown in Table 2.

TABLE 2

| True Rotation | Estimated Rotation | Estimated Translation |
|---|---|---|
| −85 | −84.73 | 74.68, 99.90 |
| −75 | −75.23 | 75.20, 99.86 |
| −65 | −65.04 | 75.60, 100.07 |
| −55 | −54.85 | 74.68, 100.28 |
| −45 | −45.00 | 75.14, 99.49 |
| −35 | −34.81 | 75.49, 100.81 |
| −25 | −24.61 | 74.00, 99.04 |
| −15 | −15.12 | 75.38, 99.70 |
| −5 | −5.28 | 74.80, 98.94 |
| 0 | 0.00 | 75.00, 100.00 |
| 5 | 4.57 | 75.17, 100.68 |
| 15 | 14.42 | 75.53, 99.49 |
| 25 | 24.61 | 74.91, 100.68 |
| 35 | 34.80 | 74.56, 99.99 |
| 45 | 45.00 | 75.38, 100.02 |
| 55 | 54.84 | 74.20, 100.98 |
| 65 | 65.04 | 75.20, 99.78 |
| 75 | 74.88 | 75.40, 100.21 |
| 85 | 84.73 | 75.94, 99.02 |

As rotation of the transformed image shifts from 85 degrees clockwise to 85 degrees counter-clockwise, the estimated registration results are close to the true transformation. The rotation errors do not exceed 1 degree and the maximum translation error in both directions is 1.06 pixels.

### Example 3

In this example the image is taken from an MRI image with size 350×350 pixels. The thresholding value used is 100. Again registration is carried out for transformed images with rotation ranging between 85 degrees clockwise and 85 degrees counter-clockwise. For all the registrations the translation is fixed at 120 pixels in the X direction and 80 pixels in the Y direction. FIGS. 6A and 6B show the reference image and one transformed image. The results of the registrations are shown in Table 3.

TABLE 3

| True Rotation | Estimated Rotation | Estimated Translation |
|---|---|---|
| −85 | −84.38 | 120.95, 80.45 |
| −75 | −74.88 | 119.64, 80.40 |
| −65 | −65.03 | 120.01, 80.69 |
| −55 | −54.49 | 120.01, 79.86 |
| −45 | −44.30 | 119.23, 80.10 |
| −35 | −35.15 | 119.90, 79.96 |
| −25 | −25.32 | 120.31, 80.29 |
| −15 | −15.82 | 120.17, 79.45 |
| −5 | −4.22 | 120.21, 80.38 |
| 0 | 0.00 | 120.00, 80.00 |
| 5 | 5.62 | 119.39, 81.14 |
| 15 | 15.47 | 119.60, 80.19 |
| 25 | 24.97 | 119.38, 80.03 |
| 35 | 35.16 | 120.13, 80.02 |
| 45 | 45.35 | 120.02, 79.12 |
| 55 | 54.85 | 120.24, 80.14 |
| 65 | 65.04 | 119.24, 79.84 |
| 75 | 74.53 | 120.59, 79.45 |
| 85 | 85.43 | 119.51, 80.16 |

Table 3 shows that as rotation shifts from 85 degrees clockwise to 85 degrees counter-clockwise, the estimated registration results are close to the true transformation. The rotation errors do not exceed 1 degree and the maximum translation error in both direction is 1.14 pixels.

### Example 4

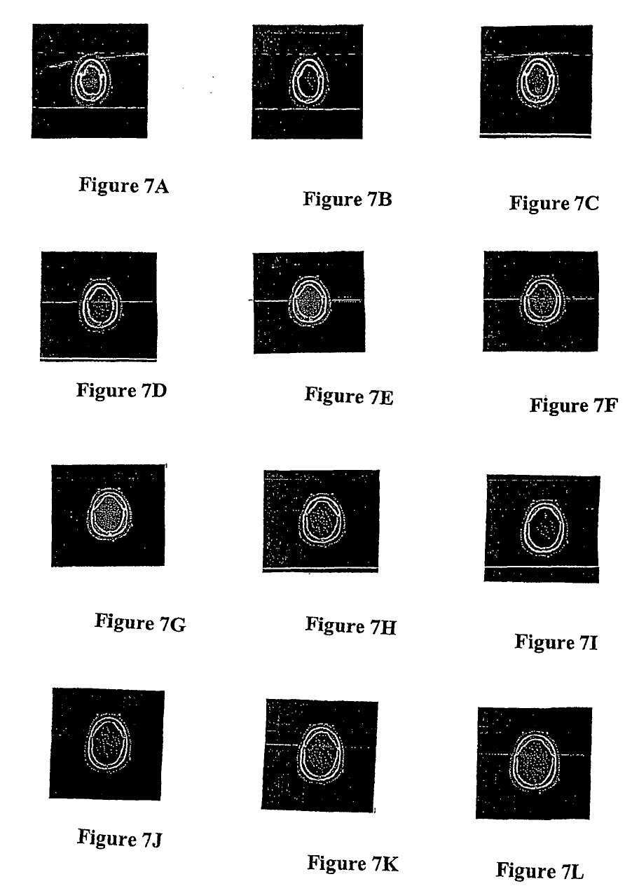

In this example registration is performed on actual CT images from the skull of a frozen cadaver. FIGS. 7A to 7L show the various skull CT images. In this example each image was registered against the next image. The results of the image registrations are shown in Table 4. In Table 4 below the estimated rotation is given in degrees either clockwise (CW) or anti-clockwise (ACW).

TABLE 4

| Reference | Transformed | Estimated | Estimated |
|---|---|---|---|
| image | image | Rotation | Translation |
| 7A | 7B | 1.06 CW | −0.42, −0.33 |
| 7B | 7C | 0.70 CW | 0.46, 0.19 |
| 7C | 7D | 0.00 | −0.43, −0.84 |
| 7D | 7E | 0.35 CW | −0.84, 0.24 |
| 7E | 7F | 0.71 ACW | −0.44, 0.63 |
| 7F | 7G | 0.35 CW | 1.32, 0.28 |
| 7G | 7H | 1.41 CW | −0.58, −1.12 |
| 7H | 7I | 0.00 | 1.54, −0.69 |
| 7I | 7J | 0.35 ACW | −0.86, −1.08 |
| 7J | 7K | 1.05 CW | −1.46, 1.20 |
| 7K | 7L | 0.39 CW | −0.96, −0.28 |
| 7L | | 0.70 CW | 1.82, −0.05 |

Normally, there should be no obvious displacement or rotation of either the object of the imaging machine, thus the true registration should be close to zero. The registration results in Table 4 are in accordance with this speculation and show that the results are close to zero despite the existence of errors.

### Example 5

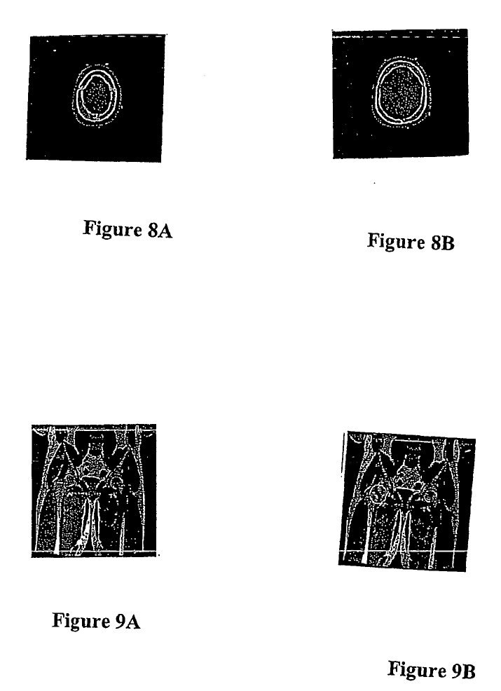

To test the influence of geometric deformation on the image registration method of the invention, two images, FIGS. 8A and 8B are registered. These images are chosen because of their obvious morphologic incongruency. Assuming the true registration to have no rotation and no translation (i.e. no moving of the object or the machine during the imaging process), the estimated registration is (0, −0.82, −0.47), that is no rotation, −0.82 pixel translation in the horizontal direction and −0.47 pixel translation in the vertical direction. This example shows that the method of the invention is able to tolerate such morphological incongruency in images.

### Example 6

This example investigates the influence of inhomogeneity information in images on registration. The reference image is shown as FIG. 9A and the transformed image is shown as FIG. 9B. As can be seen in FIG. 9B an artificial area of about 10×15 pixels is created in the image to simulate the effect of a broken femur neck. This portion is circled in FIG. 9B. Both the image of FIG. 9B with and without the broken femur were registered against the image of FIG. 9A. Without the broken femur the result was no rotation and no translation. With the break in the femur the result was no rotation but the translation is 0.42 pixels to the left horizontal direction and 0.39 pixels to the up vertical direction. These results show that the method of the invention is robust enough to tolerate such inhomogeneity information with no obvious compromise in accuracy.

### Example 7

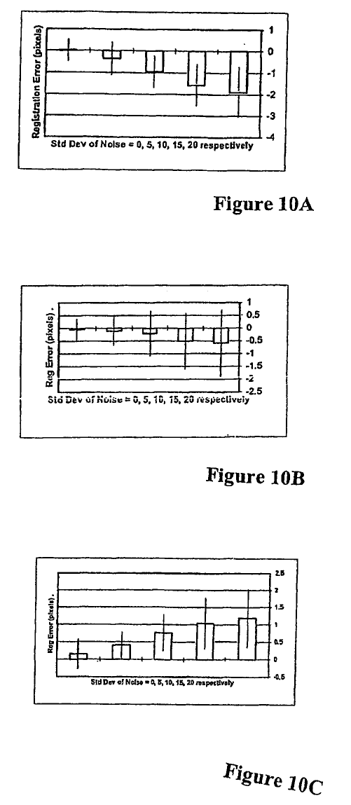

To investigate the error distribution in the registration results under different noise levels, 114 experiments were done for each Gaussian noise level with standard deviation ranging from 0 to 20. FIGS. 10A to 10C show that the method of the invention works well even when the standard deviation of the noise increases to 20 or the signal-to-noise ratio (SNR) of the image drops to 22, a situation worse than that encountered in clinical applications where the SNR value is close to 25.

FIG. 10A shows the rotation error distribution as the standard deviation of the noise increases from 0 to 20. For each bar on the graph the standard deviation of the noise is increased by five from left to right.

FIG. 10B shows the horizontal translation error (X direction) as the standard deviation of the noise increases from 0 to 20 and FIG. 10C shows the vertical translation error (Y direction) as the standard deviation of the noise increases from 0 to 20. The standard deviations of the results are shown by the error bars of these figures.

The foregoing describes the invention including preferred forms thereof. Alterations and modifications as will be obvious to those skilled in the art are intended to be incorporated in the scope hereof as defined by the accompanying claims.

1. A method of image registration including the steps of:
providing at least one point set related to the features of a reference image,
providing at least one point set related to the features of a transformed image,
estimating the translation between the reference image point set and the transformed image point set,
estimating the perspective of the image rotation for the reference image point set and the transformed image point set,
estimating the rotation between the reference image point set and the transformed image point set using the perspectives of the image rotation of the reference and transformed image point sets,
rotating the reference image point set or the transformed image point set by the estimated rotation,
translating the reference image point set or the transformed image point set by the estimated translation, and
wherein the step of translating the reference image point set or the transformed image point set can be performed at any stage after the translation has been estimated.

2. A method of image registration as claimed in claim 1 further including the steps of
rotating the reference image by the estimated rotation,
using a feature extraction method to determine a second reference image point set and
comparing this point set to the transformed image point set.

3. A method of image registration as claimed in claim 2 further including the steps of:
re-estimating the rotation after rotating the reference image and determining the second reference image point set.

4. A method of image registration as claimed in claim 3 further including the steps of:
re-estimating the translation from the geometric centers of the second reference image point set and the transformed image point set and
reapplying the re-estimated rotation and translation to the second reference image point set or the transformed image point set.

5. A method of image registration as claimed in claim 1 wherein the translation is determined by the difference between the geometric centers of the reference image point set and the transformed image point set.

6. A method of image registration as claimed in claim 1 wherein the perspectives of the image rotation are determined as the sum over all points in the reference or transformed image data sets of the absolute value of the cross product of a vector from the geometric centre to each data point and a unit vector along a rotating axis at a predetermined angle.

7. A method of image registration as claimed in claim 6 wherein the rotating axis rotates about the geometric centre of the point set.

8. A method of image registration as claimed in claim 6 wherein rotation is determined by finding the minimum of the difference between the perspective of the image rotation of the reference point set with a phase offset and the perspective of the image rotation of each transformed point set.

9. A method of image registration as claimed in claim 8 wherein the perspective of image rotation is summed over the interval of −π/2 and π/2.
